(19) United States
(12) Patent Application Publication
(10) Pub. No.: US 2003/0099689 A1
(43) Pub. Date: May 29, 2003

(54) Dietary formulations including peptides

(75) Inventors: Konrad Dabrowski, Columbus, OH (US); Kyeong-Jun Lee, Columbus, OH (US)

Correspondence Address: CALFEE, HALTER & GRISWOLD, LLP, 1650 FIFTH THIRD CENTER, 21 EAST STATE STREET, COLUMBUS, OH, 43215-4243, US

(73) Assignee: Ohio State Research Foundation, Columbus, OH

(21) Appl. No.: 10/232,156

(22) Filed: Aug. 30, 2002

Related U.S. Application Data
(60) Provisional application No. 60/316,716, filed on Aug. 31, 2001.

(51) Int. Cl. A23K 1/165; A23K 1/17

(52) U.S. Cl. 424/442; 426/635

(57) ABSTRACT

Peptide enriched diets for animals, preferably aquatic animals, intended for oral administration and including a mixture of synthetic peptide molecules, wherein the synthetic peptide molecules represent about 6 to 50% by weight of the total formulation, and wherein the synthetic peptide molecules include amino acid residues of all of the indispensable (i.e., essential) amino acids.

### CROSS REFERENCE TO RELATED APPLICATION

This application claims the benefit of U.S. Provisional Application No. 60/316,716, filed Aug. 31, 2001, entitled “Dietary Formulations Including Peptides,” the disclosure of which is incorporated as if fully rewritten herein.

### FIELD OF THE INVENTION

The present invention relates generally to improved diets for various animal species, and specifically to novel dietary regimens developed for oral administration to certain aquatic organisms, wherein the amino acid portion of the dietary regimen includes certain added dipeptide molecules.

### BACKGROUND OF THE INVENTION

Animal species that have commercial or scientific value are often fed very specific, balanced diets that are intended to increase and/or sustain the health and development of the animals. Such balanced diets typically include (i) an amino acid portion, and (ii) a portion that provides other nutrients such as carbohydrates, fibers, minerals, and/or vitamins. Specific dietary formulations and dietary regimens often vary depending on the animal species receiving the diet.

The amino acid portion of the diet is of particular interest and importance. If the animal receiving the diet is to achieve the desired growth and good health, the amino acid portion should provide the animal with the amino acids that are indispensable or essential to that particular animal species. In typical dietary formulations, the amino acid portion of the diet consists mostly of proteins that have been derived from natural sources.

The indispensable (i.e., essential) amino acids contained in purified aquatic animal diets are typically derived from one or more of the following three sources: (i) mixtures comprised solely of synthetic amino acids; (ii) isolated natural proteins supplemented with a single amino acid; or (iii) isolated natural proteins supplemented with mixtures of various amino acids. Presumably, supplementation of specific proteins included in fish diets with indispensable amino acids increases the utilization efficiency (i.e., protein gain/protein intake) of such diets and results in improved fish growth.

Varying dietary regimens, in an experimental context, may be used to characterize the effectiveness or impact of certain dietary additives or supplements. Thus, if a dietary supplement that contains a single added indispensable amino acid is used successfully as the basis for quantifying the amount amino acid conducive to optimal growth, it may be presumed that the same amino acid is used for synthesizing protein in the animal's body, regardless of whether the supplemented amino acid is protein-bound or a free form amino acid. When a series of experimental diets are administered to an animal, and each diet is supplemented with a graded level (i.e., specific dosage) of an indispensable amino acid of interest, the expected result is a gradually increasing growth rate that eventually reaches a plateau. The expected maximum growth response can then be calculated mathematically and extrapolated to the dietary level of the indispensable amino acid analyzed in a specific study.

Concerning aquatic animals, where over 130 species are relevant from a commercial perspective, the development of specific, tailored diets that provide maximum growth and optimal health are of great importance from both in practical and economic terms. Thus, there is a need for a dietary regimen of demonstrated effectiveness that provides a commercially valuable animal with the indispensable amino acids in the form of synthetic peptides.

### SUMMARY OF THE INVENTION

The present invention provides peptide, i.e., amino acid enriched dietary formulations for use with animals, preferably aquatic animals. The dietary formulations of the present invention are intended for oral administration and include a mixture of synthetic peptide molecules, wherein the synthetic peptide molecules represent about six (6) to fifty (50) percent by weight of the total formulation, and wherein the synthetic peptide molecules include amino acid residues of each of the indispensable (i.e., essential) amino acids.

The amino acid residues utilized in dietary formulations of the present invention include arginine, histidine, isoleucine, leucine, lysine, methionine, phenylalanine, threonine, tryptophan and valine. In an exemplary embodiment, these amino acid residues are in the form of synthetic dipeptides and tripeptides, or combinations thereof. In alternate embodiments, tetrapeptides and pentapeptides are also utilized.

The amino acid portion of the dietary regimens of the present invention include from about 50 to 100% synthetic peptides. In cases where less than 100% of the amino acid portion of the diet is comprised of peptides, the dietary formulations of the present invention further include free amino acids, proteins, or combinations thereof.

Further advantages of the present invention will become apparent to those of ordinary skill in the art upon reading and understanding the following detailed description of the preferred embodiments.

### DETAILED DESCRIPTION OF THE INVENTION

Amino acids are the basic biological chain unit of proteins and polypeptides. Some amino acids can be synthesized by animals, with this ability varying somewhat between animal species. Amino acids that cannot be synthesized by a particular animal species are referred to as essential amino acids. In the context of this invention, the term “indispensable” is used interchangeably with the term “essential,” both terms having the same definition.

The present invention provides novel dietary formulations designed specifically for oral administration to various animal species. The animals which may receive these formulations will typically be animals with commercial value such as livestock and various aquatic species; however, certain embodiments of this invention may be fed to humans or other animals, as well. These dietary formulations are typically administered to the animal by direct feeding, either voluntarily or through the use of a feeding tube.

Fish that are offered a diet that includes amino acid mixtures often suffer inferior growth compared to fish offered diets supplemented with protein (e.g., casein-gelatin). The present invention overcomes the problem of inferior growth by utilizing a mixture of synthetic dipeptides or other peptides of varying length. Upon consumption and digestion, this mixture of synthetic dipeptides provides the fish with indispensable amino acids. Because the problem of inferior growth is overcome by diets including synthesized peptides of varying length, such diets are preferable to purified diets which provide aquatic organisms with non-hydrolyzed protein or a free amino acid mixture.

Depending on the animal receiving the dietary formulation, the amino-acid providing portion of the formulation represents about six (6) to fifty (50) percent by weight of the total formulation. In an exemplary embodiment of this invention, at least 50%, preferably at least 75%, and more preferably at least 90% of the amino acid portion of the diet will be a mixture of peptides. If the amino acid portion is less than 100% peptides, the remainder of the amino acid portion typically includes free amino acids, proteins, or combination thereof. In embodiments of the present invention that include a protein component, a casein-gelatin mixture (at a ratio of about 8:1) is preferred. However, the protein may be derived from other purified sources such as gluten, zein, and protamine.

The peptides mixtures used in the exemplary formulations of this invention are typically in the form of dipeptides and/or tripeptides. Longer peptide chains are also contemplated by the present invention, including tetrapeptides and pentapeptides, and alternate dietary formulations of this invention include and utilize these longer peptides. Dipeptides are preferable for reasons that include ease of chemical synthesis and ease of absorption and hydrolysis by the animal receiving the diet. The peptides utilized herein typically comprise from 2 to 3 amino acids connected by a peptide bond. In one embodiment, each peptide in the mixture comprises the same amino acid; an example being the dipeptide lys-lys. In alternative embodiments, one or more, or all of the peptides in the mixture, comprise different amino acids; examples being the dipeptides gly-lys and asp-arg. Preferably, the amino acids in the peptides of the present invention are indispensable amino acids, although in certain cases non-essential amino acids may be included.

This invention also includes formulations wherein one or more indispensable amino acids are withdrawn and/or added in graded concentrations. Adding or withdrawing amino acids in this fashion is useful for determining the level (i.e., amount, percent, dosage, etc.) of amino acid useful for optimizing a dietary formulation, or for characterizing the interaction of multiple amino acids (e.g., lysine and arginine) in a dietary formulation. Such characterization is an important aspect of optimizing diets to achieve the maximum growth possible for an aquatic organism.

By way of example, in formulations that address lysine consumption, the peptide-based diet of the present invention contains all of the indispensable amino acids in the form of peptides which are added to provide the equivalent of 45-50% by weight of the protein in a dry diet. A control diet would be completely devoid of lysine. A series of diets with a graded level of peptide, for example lys-gly, is supplemented to provide 0.8, 1.0, 1.2, 1.4 and 1.6% by weight of lysine. To keep diets isonitrogenous, gly-gly dipeptides are added to balance total “protein.” Typically, the growth response resulting from these treatments includes enhanced weight gain until a plateau is reached. Thus, the lysine requirement is determined by the least amount of supplemental lysine in peptide form for maximum growth.

Advantageously, the dietary regimens of the present invention may be formulated for a wide range of organisms at various stages in their life cycles. For example, these diets are suitable for the larval stages of certain aquatic invertebrates and larval fish that require food particle sizes in the range of 5-50 and 50-200 μm, respectively. Concerning larval fish diet formulations, the diets of the present invention may provide between 6 and 50% by weight in the form of a specific peptide formulation. While a negative nitrogen balance is found in first-exogenous feeding fish offered diets consisting of amino acid mixtures, positive growth results from peptide based diets.

Example 1 (see below) describes a feeding test using rainbow trout alevins (the first exogenous feeding) and juveniles (0.8 g individual weight) to compare the effect on growth and metabolism of diets containing a protein, dipeptide mixture, and an amino acid mixture formulated to meet indispensable amino acid requirements known from the literature. The diets used were also supplemented with 15% of maca (Lepidium meyenii) concentrate to increase feed acceptance and growth of rainbow trout without significant enhancement in dietary protein content (approximately 1.5%). The results of the tests demonstrate that the dipeptide based diet gave positive growth rate of rainbow trout alevins in comparison to complete emaciation and mortality of fish fed an amino acid-based diet (Table 1).

The conclusions that can be drawn from Example 1 are embodied in the dietary formulations, which may also address needs for other aquatic organisms, and encompass optimized (maximum growth) proportions of protein and dipeptides as nutrients and synthetic amino acids supplement as attractants. For example, a free amino acid diet was most vigorously consumed, and it is evident from the literature that several amino acids, such as proline and glycine in rainbow trout, accelerate feed acceptance and increase feed intake.

Typically, such diets include 15-45% protein, 6-50% dipeptides, and 1-5% free amino acids by weight. In the case of purified diets formulated for requirement studies, specific dipeptides containing indispensable amino acids will be completely withdrawn or supplemented at a graded level. In rainbow trout alevins offered a synthetic free amino acid diet, catabolic rate of dietary amino acids measured as excreted ammonia was increased 72% over a control (CM), protein-based diet, and by 47% over a peptide-based diet fed fish (Table 1). In other words, dietary amino acids were deaminated and wasted as energy source rather than for protein synthesis (growth). Thus, peptides appear provide multiple advantages to the growing animal. Peptides are the only available form of essential amino acids in larval fish, and are a more efficient source of amino acids in larger fish.

### EXAMPLE 1

An experiment on rainbow trout alevins following yolk sac absorption was performed with four diets formulated to contain proteins, dipeptides, or synthetic amino acids as a sole nitrogen source. The two control diets were formulated to contain casein (40%), gelatin (8%), dextrin (6.25%), wheat meal (0 or 15%), maca meal (0, control diet C or 15%, control diet CM), protein concentrate (5%), cod liver oil (14%), choline chloride (1%), mineral and vitamin mixtures (3 and 4%), carboxymethylcellulose (2%), and three supplemental free L-amino acids, arginine (0.5%), methionine (0.4%), and lysine (0.8%). In the following experimental diets, casein-gelatin (48%) was replaced with isonitrogenous amount of peptides (PP) or free amino acids (AA) and the remaining ingredients (lipids, minerals, vitamins, maca meal, etc.) were the same.

The diet composed of synthetic dipeptides contained, by wieght: arginine-valine (2.87%), histidine-leucine (1.21%), glycine-isoleucine (1.41%), lysine-glycine (2.96%), glycine-methionine (1.38%), phenylalanine-leucine (3.03%), threonine-leucine (1.56%), glycine-tryptophan (0.26%), and valine-leucine (0.45%), and three sources of dispensible amino acids, alanine-glycine (10%), alanine-glutamine (15%), and glycine-tyrosine (4.95%).

The diet composed of synthetic L-amino acids contained: ten indispensable L-amino acids: arginine (1.5%), histidine (0.7%), isoleucine (0.9%), leucine (2.9%), lysine (1.8%), methionine (1%), phenylalanine (1.8%), threonine (0.8%), tryptophan (0.2%), and valine (0.2%), and three of dispensable L-amino acids of proline (11.1%), serine (11.1%), and alanine (11.1%).

Differences in growth between two ontogenic stages of rainbow trout (alevins and juveniles) were observed among fish fed protein-based, peptide-based, and amino acid-based diets (see Table 1). The amino acid-based diet resulted in loss of body weight and signs of emaciation. Additionally, in this test group, postprandial metabolic losses of ammonia were significantly higher than in any other group. This suggests an enhanced rate of deamination of amino acids in fish fed AA diet and its loss for protein synthesis (growth) and possibly use as an energy source.

TABLE 1
Comparison of dietary regimens.

| Diet | C | CM | AA | PP |
|---|---|---|---|---|
| Body weight | 0.49 ± 0.02 | 0.79 ± 0.05 | 0.13 ± 01 | 0.26 ± 0.02 |
| (g, 4 weeks) | | | | |
| Weight gain | 338 ± 17 | 604 ± 48 | 11 ± 7 | 134 ± 14 |
| (%) | | | | |
| Ammonia | 19.9 ± 3.1 | 17.6 ± 3.2 | 30.3 ± 3.1 | 21.3 ± 1.3 |
| excretion | | | | |
| (ug N/g/h) | | | | |

C—casein-gelatin
CM—casein-gelatin plus Lepidium (maca meal)
AA—amino acid diet
PP—dipeptide diet
Note: Positive growth noted in this Table in respect to fish fed an AA diet was the result of selective mortality of smaller fish. Overall survival afler 4 weeks in this treatment was 11 ± 4%

### EXAMPLE 2

The second experiment on starter feeding of rainbow trout alevins was performed using six diets formulated to contain proteins, dipeptides or a mixture of thereof, or synthetic amino acids as a sole nitrogen source. The commercial starter diet was used as an additional control (Comm). The control diet was formulated to contain casein (40%), gelatin (8%), dextrin (19.25%), attractant-soluble fish protein concentrate (5%), cod liver oil (10%), lecithin (6%), mineral and vitamin mixture (3 and 4%), choline chloride (1%) and a supplement of free L-amino acids, arginine, methionine and lysine (0.5, 0.4 and 0.8%).

The dipeptide diet composed of synthetic dipeptides (PP, example 1) contained similar compositions as in synthetic L-amino acids diet (AA). For the mixture of dipeptides and casein-gelatin (50PP), casein-gelatin was replaced with synthetic dipeptides on 50% nitrogen-basis. An additional diet (a peptide only containing) was formulated to examine deficiency symptoms of an indispensable amino acid, L-arginine. In this diet, arginine-valine and leucine-arginine were replaced with both alanine-glutamine and valine-leucine on the weight basis (PP w/o Arg).

Differences in growth and survival after the first two weeks of the experiment were highly significant (Table 2). The AA and w/o Arg diets fed alevins have shown body weight loss and signs of emaciation.

TABLE 2
Comparison of fish performance.

| | | | | | PP w/o | |
|---|---|---|---|---|---|---|
| Diets | C | 50PP | PP | AA | Arg | Comm. |
| Body weight | 0.124 ± | 0.144 ± | 0.127 ± | 0.099 ± | 0.096 ± | 0.142 ± |
| (mg, 2 weeks) | 0.007 | 0.039 | 0.054 | 0.031 | 0.030 | 0.014 |
| Mortality (%) | 12.5 ± | 14.2 ± | 16.7 ± | 55.8 ± | 61.7 ± | 12.5 ± |
| | 5.8 | 2.9 | 3.8 | 2.9 | 3.8 | 5.0 |

C: casein-gelatin
50PP: 50% dipeptide + 50% casein-gelatin diet
PP: dipeptide diet
AA: amino acid diet
PP w/o Arg: arginine-depleted dipeptide diet
Comm: a commercial diet

The arginine-deficient diet fed to fish illustrates acute symptoms of indispensable amino acid deficiency. This clearly demonstrates that a “peptide” diet is an excellent source to re-examine amino acid requirement in larval and juvenile fish.

Peptide-based diets provide a tool to validate earlier results obtain with semi-purified diets. Therefore, both diet formulations for analysis of nutrient requirements (semi-purified diets) and practical diets with the least-cost incentive (plant proteins supplemented with peptides containing essential amino acids) are important applications of the present invention. As synthetic amino acids are common dietary supplements in animal feed industry, as well as a human nutrient supplement, a new generation of supplements of peptides containing essential amino acids may prove biologically more efficient and safer. Thirdly, larval fish and crustacean diets which failed to support growth when based on proteins or free amino acid mixtures may be dramatically improved by providing synthetic dipeptides as the major source of amino acids.

While the above description contains many specificities, these should not be construed as limitations on the scope of the invention, but rather as exemplification of preferred embodiments. Numerous other variations of the present invention are possible, and it is not intended herein to mention all of the possible equivalent forms or ramifications of this invention. Various changes may be made to the present invention without departing from the scope of the invention.

What is claimed:

1. A dietary formulation for oral administration to animals, comprising a mixture of synthetic peptide molecules, wherein said synthetic peptide molecules represent about 6 to 50% by weight of the total formulation, and wherein said synthetic peptide molecules include amino acid residues of indispensable amino acids.

2. The dietary formulations of claim 1, wherein said animals are aquatic organisms.

3. The dietary formulation of claim 1, wherein said amino acid residues comprise arginine, histidine, isoleucine, leucine, lysine, methionine, phenylalanine, threonine, tryptophan and valine.

4. The dietary formulation of claim 1, wherein said amino acid residues comprise synthetic dipeptides and tripeptides, or combinations thereof.

5. The dietary formulation of claim 1, wherein the optimal percentage of each amino acid present in said formulation is determined by adding or withdrawing said amino acid to or from a formulation in a graded manner.

6. A dietary formulation for oral administration to animals, comprising a mixture of synthetic peptide molecules, wherein said synthetic peptides comprise from about 50 to 100% of the amino acid portion of said dietary formulation.

7. The dietary formulation of claim 6, wherein said synthetic peptide molecules comprise less than 100% of the amino acid portion of said dietary formulation, and wherein said dietary formulation further comprises amino acids, proteins, or combinations thereof.
